(19) United States
(12) Patent Application Publication
(10) Pub. No.: US 2013/0080029 A1
(43) Pub. Date: Mar. 28, 2013

(54) FAIL SAFE ELECTRONIC THROTTLE CONTROL PEDAL SENSOR

(71) Applicants: Leo P. Dion, Flint, MI (US); Brian J. Pellerito, Ortonville, MI (US)

(72) Inventors: Leo P. Dion, Flint, MI (US); Brian J. Pellerito, Ortonville, MI (US)

(73) Assignee: GM Global Technology Operations LLC, Detroit, MI (US)

(21) Appl. No.: 13/242,178

(22) Filed: Sep. 23, 2011

(51) Int. Cl. F02D 41/10

(52) U.S. Cl. 701/103

(57) ABSTRACT

A system includes a pedal override module that receives a pedal position from an accelerator pedal position sensor, receives a pedal pressure from an accelerator pedal pressure sensor, compares the pedal position to the pedal pressure, and selectively outputs a pedal override signal based on the comparison between the pedal position and the pedal pressure. A throttle position control module controls a position of a throttle based on the pedal position and the pedal override signal.

### FIELD

The present disclosure relates to throttle control in a vehicle, and more particularly to throttle control using an accelerator pedal position sensor and an accelerator pedal pressure sensor.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A driver controls engine and vehicle speed in a vehicle driven by internal combustion engine, a hybrid, and/or an electric vehicle using an actuator such as an accelerator pedal. For example, the driver applies pressure to the accelerator pedal to actuate a throttle. A pedal position sensor determines a position of the accelerator pedal and controls a throttle position based on the pedal position and various other factors. The resultant throttle position determines speed and acceleration of the vehicle.

### SUMMARY

A system includes a pedal override module that receives a pedal position from an accelerator pedal position sensor, receives a pedal pressure from an accelerator pedal pressure sensor, compares the pedal position to the pedal pressure, and selectively outputs a pedal override signal based on the comparison between the pedal position and the pedal pressure. A throttle position control module controls a position of a throttle based on the pedal position and the pedal override signal.

In other features, a method includes receiving a pedal position from an accelerator pedal position sensor, receiving a pedal pressure from an accelerator pedal pressure sensor, comparing the pedal position to the pedal pressure, selectively outputting a pedal override signal based on the comparison between the pedal position and the pedal pressure, and controlling a position of a throttle based on the pedal position and the pedal override signal.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a vehicle including an accelerator pedal pressure sensor according to the present disclosure;

FIG. 2 is a schematic illustration of an accelerator pedal assembly according to the present disclosure;

FIG. 3 is a functional block diagram of the accelerator pedal assembly and a control module according to the present disclosure; and

FIG. 4 is a flow diagram illustrating an accelerator pedal pressure sensing method according to the present disclosure.

### DETAILED DESCRIPTION

The following description is merely illustrative in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors or a group of execution engines. For example, multiple cores and/or multiple threads of a processor may be considered to be execution engines. In various implementations, execution engines may be grouped across a processor, across multiple processors, and across processors in multiple locations, such as multiple servers in a parallel processing arrangement. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

A pedal position sensor is arranged to sense a pedal position of an accelerator pedal in a vehicle. Accordingly, the pedal position sensor may be indicative of driver intent with respect to speed and/or acceleration of the vehicle. A vehicle according to the present disclosure includes a pedal pressure sensor in addition to the pedal position sensor to provide a further indicator of driver intent.

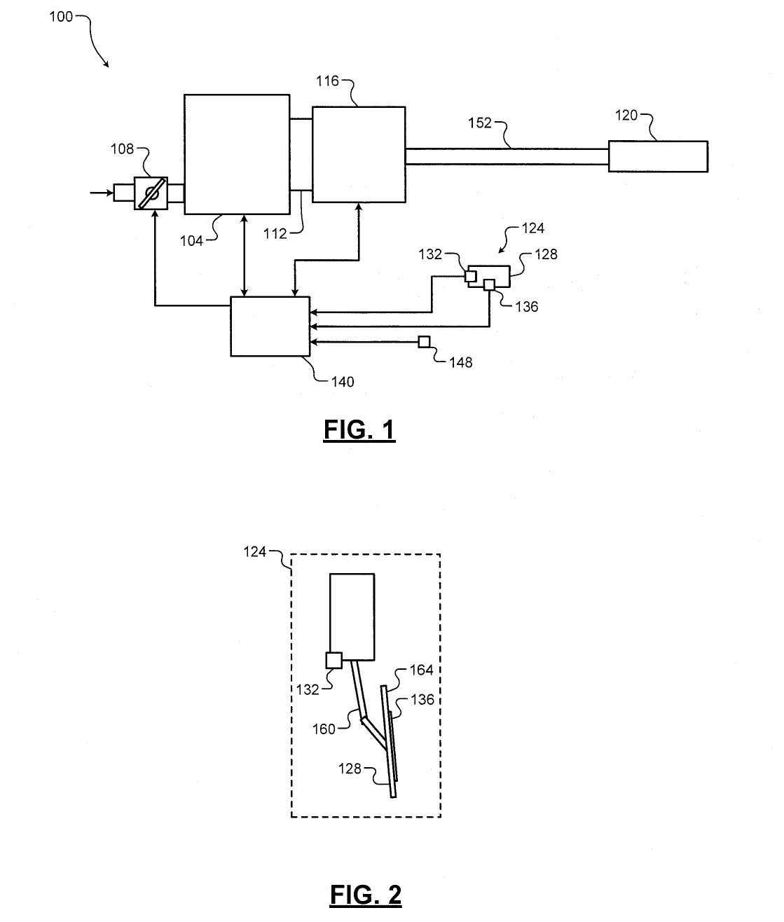

Referring now to FIG. 1, a vehicle 100 includes an engine 104. The engine 104 combusts an air and fuel mixture within cylinders (not shown) to produce drive torque. Air is drawn into the engine 104 through a throttle 108. A torque converter 112 transfers and multiplies torque from the engine 104 and provides the torque to a transmission 116. The transmission 116 operates in one or more gear ratios to transfer the torque to a driveline 120. Although the vehicle 100 including an internal combustion engine is described, it is to be understood that the principles of the present disclosure may also be applied to a vehicle including a hybrid powertrain and/or an electric vehicle.

An accelerator pedal assembly 124 enables a driver of the vehicle 100 to adjust the position of the throttle 108 to achieve a desired speed. The accelerator pedal assembly includes an accelerator pedal 128, an accelerator pedal position sensor 132, and an accelerator pedal pressure sensor 136. The accelerator pedal position sensor 132 generates a pedal position signal indicating a position of the accelerator pedal 128. The accelerator pedal pressure sensor 136 generates a pedal pressure signal indicating an amount of pressure applied to the accelerator pedal 128 by a driver. A control module 140 receives the pedal position signal and the pedal pressure signal and adjusts the position of the throttle 108 accordingly, which adjusts airflow into the engine 104. The control module 140 adjusts fuel delivery to the engine 104 based on the airflow.

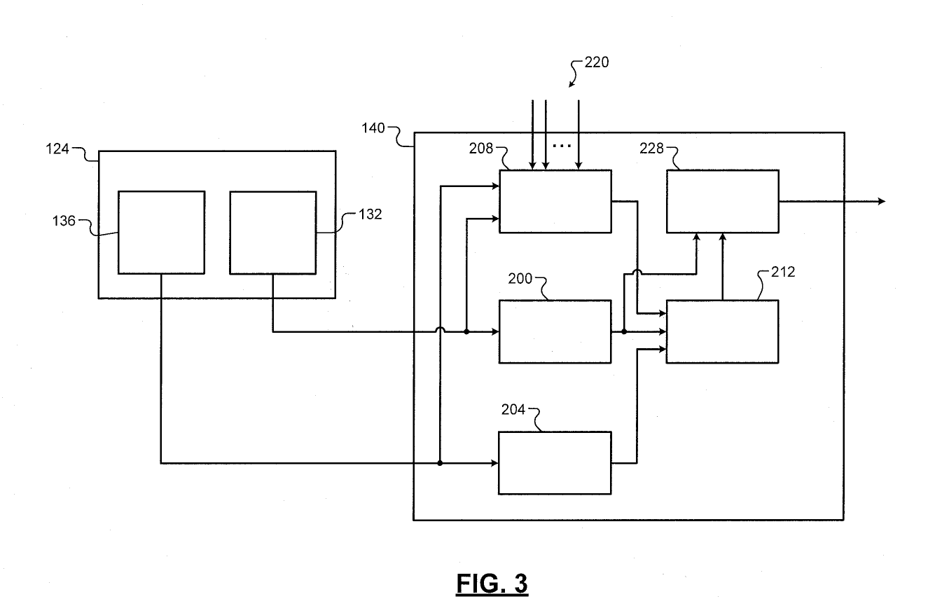

Referring now to FIG. 2, the accelerator pedal assembly 124 is shown to include the accelerator pedal 128, the accelerator pedal position sensor 132, the accelerator pedal pressure sensor 136, and an accelerator pedal arm 160. When the accelerator pedal 128 is actuated (e.g., when the driver depresses the accelerator pedal 128), the accelerator pedal arm 160 changes position accordingly. The accelerator pedal position sensor 132 senses the position of the accelerator pedal 128 and/or the accelerator pedal arm 160 and generates the pedal position signal accordingly.

For example only, the accelerator pedal position sensor 132 includes a rotational sensor that senses a rotational position of the accelerator pedal arm 160. The accelerator pedal position sensor 132 generates the pedal position signal indicative of the position of the accelerator pedal 128 regardless of whether pressure is actually applied to the accelerator pedal 128. In other words, the accelerator pedal position sensor 132 generates the pedal position signal independently of pressure sensed by the accelerator pedal pressure sensor 136.

The accelerator pedal pressure sensor 136 is arranged on a contact surface (e.g., a foot plate) 164 of the accelerator pedal 128. Although only a single accelerator pedal pressure sensor 136 is shown, it is to be understood that multiple pressure sensors may be provided. For example, multiple pressure sensors may be provided to sense the pressure applied to the accelerator pedal 128 regardless of where the driver contacts the contact surface 164.

The accelerator pedal pressure sensor 136 senses pressure applied to the contact surface 164 of the accelerator pedal 128 and generates the pedal pressure signal accordingly. The accelerator pedal pressure sensor 136 generates the pedal pressure signal indicative of the pressure applied to the accelerator pedal 128 regardless of the position of the accelerator pedal 128 and the corresponding pedal position signal. In other words, the accelerator pedal pressure sensor 136 generates the pedal pressure signal independently of the position sensed by the accelerator pedal position sensor 132. For example, if the driver is not applying pressure to the accelerator pedal 128 but the accelerator pedal is in a depressed position, the accelerator pedal pressure sensor 136 continues to indicate via the pedal pressure signal that no pressure is applied to the accelerator pedal 128. Accordingly, the accelerator pedal pressure sensor 136 accurately indicates driver intent notwithstanding the position sensed by the accelerator pedal position sensor 132.

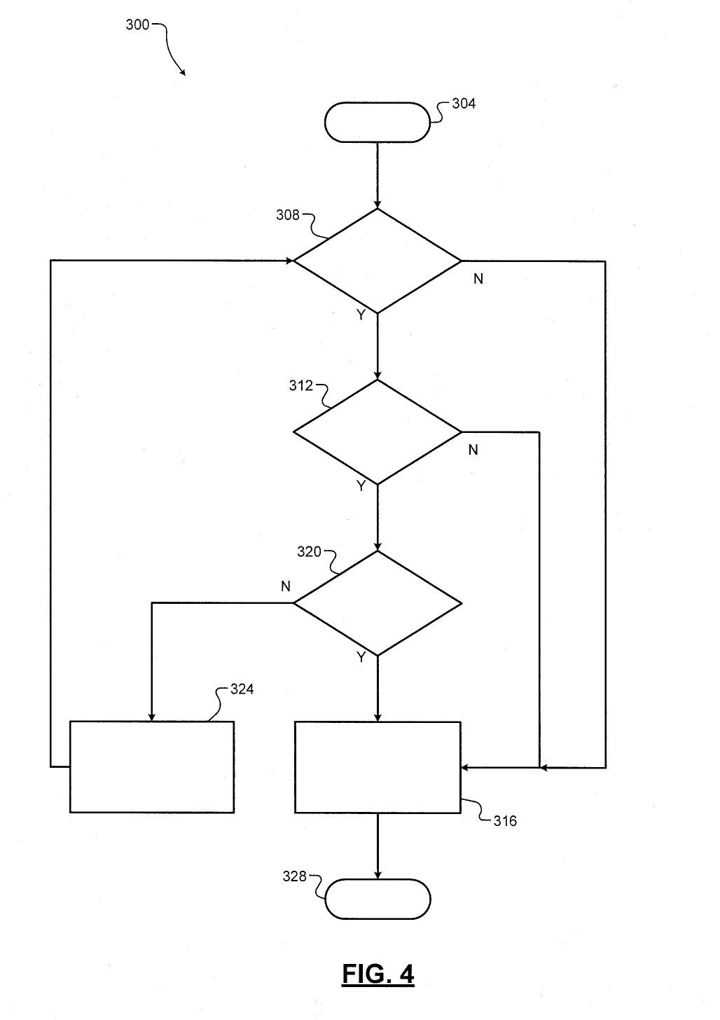

Referring now to FIG. 3, the control module 140 includes a pedal position determination module 200, a pedal pressure determination module 204, a pedal sensor diagnostic module 208, and an accelerator pedal override module 212. The pedal position determination module 200 receives the pedal position signal from the accelerator pedal position sensor 132 and determines a pedal position accordingly. The pedal position determination module 200 provides the pedal position to the accelerator pedal override module 212. The pedal pressure determination module 204 receives the pedal pressure signal from the accelerator pedal pressure sensor 136 and determines a pedal pressure accordingly. The pedal pressure determination module 204 provides the pedal pressure to the pedal override module 212.

The pedal sensor diagnostic module 208 receives the pedal position signal, the pedal pressure signal, and one or more other signals 220. The pedal sensor diagnostic module 208 performs diagnostics on the accelerator pedal position sensor 132 and the accelerator pedal pressure sensor 136 based on the pedal position signal, the pedal pressure signal, and the signals 220. For example, the pedal sensor diagnostic module 208 determines whether the pedal position signal and/or the pedal pressure signal are valid. For example only, the pedal position signal or the pedal pressure signal may not be valid due to a faulty accelerator pedal position sensor 132 or accelerator pedal pressure sensor 136, respectively. Alternatively, the pedal position signal or the pedal pressure signal may not be valid due to other factors interfering with the pedal position signal or the pedal pressure signal. For example, the pedal sensor diagnostic module 208 may detect electrical shorts to power or ground and/or an open circuit associated with the sensors 132 and 136 or other relevant circuitry. The pedal sensor diagnostic module 208 generates one or more sensor diagnostic signals indicating whether the pedal position signal and/or the pedal pressure signal are valid and provides the sensor diagnostic signals to the pedal override module 212.

The pedal override module 212 determines whether to override the pedal position based on the pedal position, the pedal pressure, and the sensor diagnostic signals. For example, a throttle position control module 228 may generally provide a throttle position control signal to the throttle 108 based on the pedal position. Accordingly, the throttle position control module 228 controls a position of the throttle 108. However, the pedal override module 212 may output a pedal position override signal to the throttle position control module 228 based on the pedal position, the pedal pressure, and the sensor diagnostic signals.

For example, the pedal override module 212 may output the pedal position override signal if the sensor diagnostic signals indicate that the pedal position and/or pedal pressure are not valid. Further, the pedal override module 212 may compare the pedal position and the pedal pressure and output the pedal position override signal if the pedal position and the pedal pressure provide contradictory indications of driver intent. For example only, if the pedal position indicates a high pedal position (e.g., a position greater than or equal to a pedal position threshold, where a high pedal position indicates a high rotational degree of actuation of the accelerator pedal 128) but the pedal pressure indicates low pressure on the accelerator pedal 128 (e.g., a pressure less than a pedal pressure threshold), then the pedal position and the pedal pressure may indicate contradictory indications of driver intent. In other words, in this situation, the accelerator pedal 128 may be in a depressed position without any pressure applied by the driver, and therefore without driver intent.

The pedal position and the pedal pressure may also provide contradictory indications of driver intent if the pedal pressure is not within a predetermined range of the pedal position. For example, the pedal pressure may be indexed to a corresponding pedal position. If the pedal position corresponding to the pedal pressure is not within the predetermined range of the sensed pedal position, the pedal override module 212 may output the pedal position override signal. Those skilled in the art can appreciate that other methods of analyzing the pedal position and the pedal pressure to determine whether the pedal position accurately indicates driver intent are anticipated.

Accordingly, the throttle position control module 228 may disregard the pedal position in response to the pedal position override signal. For example, the throttle position control module 228 may temporarily control the throttle 108 based on other signals, or may limit the performance capabilities of the vehicle until the vehicle is serviced. For example only, a positional range of the throttle 108 may be limited to a percentage of the entire range (e.g., 0-8 percent of the entire range), which limits engine torque. The control module 140 may take remedial actions to stop the vehicle, and/or provide information to the driver (e.g., via a check engine light) that a fault has occurred and the vehicle should be serviced. For example only, the vehicle 100 may include a second accelerator pedal position sensor (not shown) to provide redundancy in case the accelerator pedal position sensor 132 is faulty.

Referring now to FIG. 4, an accelerator pedal pressure sensing method 300 begins at 304. At 308, the method determines whether the pedal position is valid. If true, the method 300 continues to 312. If false, the method 300 continues to 316. At 312, the method 300 determines whether the pedal pressure is valid. If true, the method 300 continues to 320. If false, the method 300 continues to 316. At 320, the method 300 determines whether the pedal position and the pedal pressure provide contradictory indications of driver intent. If true, the method 300 continues to 316. If false, the method 300 continues to 324. At 324, the method 300 controls throttle position according to pedal position. At 316, the method 300 generates a pedal position override signal and/or takes other remedial actions. The method 300 ends at 328.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A system comprising:
a pedal override module that receives a pedal position from an accelerator pedal position sensor, receives a pedal pressure from an accelerator pedal pressure sensor, compares the pedal position to the pedal pressure, and selectively outputs a pedal override signal based on the comparison between the pedal position and the pedal pressure; and
a throttle position control module that controls a position of a throttle based on the pedal position and the pedal override signal.

2. The system of claim 1 wherein the throttle position control module disregards the pedal position based on the pedal override signal.

3. The system of claim 1 wherein the pedal override module outputs the pedal override signal when the pedal position is greater than or equal to a pedal position threshold and the pedal pressure is less than a pedal pressure threshold.

4. The system of claim 1 wherein the pedal override module outputs the pedal override signal when the pedal pressure is not within a predetermined range of the pedal position.

5. The system of claim 1 further comprising a pedal sensor diagnostic module that generates a sensor diagnostic signal based on at least one of the pedal position and the pedal pressure, wherein the pedal override module outputs the pedal override signal when the sensor diagnostic signal indicates that the at least one of the pedal position and the pedal pressure is not valid.

6. The system of claim 1 further comprising an accelerator pedal assembly that includes an accelerator pedal, the accelerator pedal position sensor and the accelerator pedal pressure sensor.

7. The system of claim 6 wherein the accelerator pedal pressure sensor is arranged on a contact surface of the accelerator pedal.

8. A method comprising:
receiving a pedal position from an accelerator pedal position sensor;
receiving a pedal pressure from an accelerator pedal pressure sensor;
comparing the pedal position to the pedal pressure;
selectively outputting a pedal override signal based on the comparison between the pedal position and the pedal pressure; and
controlling a position of a throttle based on the pedal position and the pedal override signal.

9. The method of claim 8 further comprising disregarding the pedal position based on the pedal override signal.

10. The method of claim 8 further comprising outputting the pedal override signal when the pedal position is greater than or equal to a pedal position threshold and the pedal pressure is less than a pedal pressure threshold.

11. The method of claim 8 further comprising outputting the pedal override signal when the pedal pressure is not within a predetermined range of the pedal position.

12. The method of claim 8 further comprising generating a sensor diagnostic signal based on at least one of the pedal position and the pedal pressure, wherein the pedal override signal is output when the sensor diagnostic signal indicates that the at least one of the pedal position and the pedal pressure is not valid.

13. The method of claim 8 further comprising providing an accelerator pedal assembly that includes an accelerator pedal, the accelerator pedal position sensor and the accelerator pedal pressure sensor.

14. The method of claim 13 further comprising arranging the accelerator pedal pressure sensor on a contact surface of the accelerator pedal.
